(19) United States
(12) Patent Application Publication
(10) Pub. No.: US 2005/0262401 A1
(43) Pub. Date: Nov. 24, 2005

(54) Central processing unit and micro computer

(75) Inventor: Yasuhiko Saitou, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC ELECTRONICS CORPORATION

(21) Appl. No.: 11/108,647

(22) Filed: Apr. 19, 2005

(30) Foreign Application Priority Data
Apr. 21, 2004 (JP) 126089/2004

(51) Int. Cl. G06F 11/00

(52) U.S. Cl. 714/42

(57) ABSTRACT

A central processing unit has a cache memory, a test circuit connected to the cache memory, and a result storage area. The test circuit stores a test pattern which is programmable and is used for checking the cache memory. The test circuit instructs read and write data to the cache memory according to the test pattern. A result data read out from the cache memory is stored in the result storage area.

### BACKGROUND OF THE INVENTION

1. Field of the Invention

The present invention relates to a central processing unit and a micro computer. More particularly, the present invention relates to a central processing unit and a micro computer which have a circuit for checking a built-in cache memory.

2. Description of the Related Art

In recent years, a central processing unit (CPU) has a built-in cache memory in order to increase the processing power of a micro computer, and it is required to improve a clock frequency (internal clock) at which the CPU operates. As for circuits outside of the CPU, the operation speed as high as that of the CPU is not necessary, and it is preferable to utilize intellectual properties such as macros which were developed in the past. Thus, a clock (external clock) of a frequency lower than that of the internal clock is provided for those circuits outside of the CPU.

Operation tests for discriminating between defective units and non-defective units are performed on such a micro computer. The operation tests include a test for a cache memory. Conventionally, a “cache test mode (CTM)” and a “BIST (Built-in Self Test) mode” are known as modes for checking the cache memory.

According to the cache test mode, addresses are specified and test data are written in response to signals which are inputted from outside of the micro computer. In other words, writing and reading of data to the cache memory is carried out on the basis of the “external clock”. Such a test method in which a memory is directly accessed from the outside and the cache test is carried out is disclosed in Japanese Laid Open Patent Application JP-A-Showa 60-189047.

On the other hand, according to the BIST mode, a test of the cache memory is performed in accordance with a test pattern built in the CPU and is carried out on the basis of the “internal clock”. The test pattern includes a group of data/addresses/commands used in checking the cache memory. Also, the test pattern is incorporated and fixed in the CPU beforehand. According to the BIST mode, whether or not there is a failure in the CPU as a whole is detected, and a final result, namely, a signal indicative of the pass or fail is outputted.

### SUMMARY OF THE INVENTION

The present invention has recognized the following points. That is, the cache memory which is built-in the CPU operating at the internal clock operates in synchronization with the internal clock. As a test for the cache memory, a test of “consecutive access” is necessary in which the access to the cache memory is consecutively carried out in terms of time or position. In the consecutive access, for example, accesses to adjacent memory cells connected to an identical word line are successively carried out. Also in the consecutive access, for example, data are successively written to or read out from memory cells connected to an identical bit line.

However, the consecutive access to the cache memory in the cache test mode is a consecutive access based on the external clock, which is “not consecutive” in terms of the internal clock. That is to say, in the cache test mode, a write data and an access target address are fixed for several cycles of the internal clock. Thus, it is not possible according to the cache test mode to detect failures which may be caused by the “consecutive access” based on the internal clock.

On the other hand, according to the BIST mode, only a final result (pass or fail) is outputted. Thus, it is not possible according to the BIST mode to analyze which part of the cache memory causes the detected failure. Hence, it is necessary to generate a compound event at a function test in order to detect failures. Here, the difficulty level of making a function pattern used in the function test is high, and the time required for preparing the function pattern is long.

In an aspect of the present invention, a central processing unit includes a cache memory, a test circuit connected to the cache memory, and a result storage area. The test circuit stores a test pattern which is programmable and is used for checking the cache memory. Also, the test circuit instructs reading and writing of data to the cache memory according to the test pattern. A result data read out from the cache memory is stored in the result storage area. The result storage area can have a shift register including a plurality of registers. In this case, a plurality of result data are sequentially stored in the plurality of registers.

As described above, the reading and writing of test data to the cache memory are carried out on the basis of an internal clock at which the central processing unit operates. it is therefore possible to detect failures which are caused by a “consecutive access” based on the internal clock.

A micro computer according to the present invention has the above-mentioned central processing unit and an input-output port connected to the central processing unit. The test pattern is written from the input-output port to the test circuit. Also, the result data is outputted from the result storage area to the input-output port.

As described above, since all the result data are outputted from the micro computer, it is possible to analyze a failure of the cache memory in detail and to make it easier to specify a cause of the failure. Moreover, the test pattern is programmable and is not fixed beforehand. Based on the outputted result data, a user can set a new test pattern by using a tester. Thus, the user can narrow down the cause of the failure of the cache memory with ease.

According to the central processing unit and the micro computer of the present invention, it is possible to detect a failure of the cache memory which is caused by a consecutive access based on the internal clock.

According to the central processing unit and the micro computer of the present invention, it is possible to analyze a cause of the failure of the cache memory without using a function pattern.

### BRIEF DESCRIPTION OF THE DRAWINGS

The above and other objects, advantages and features of the present invention will be more apparent from the following description taken in conjunction with the accompanying drawings, in which:

FIG. 1 is a block diagram showing a configuration of a micro computer according to the present invention;

FIG. 2 is a block diagram showing a configuration of a central processing unit according to a first embodiment of the present invention;

FIG. 3 is a table showing contents of a test pattern according to the present invention;

FIG. 4 is a timing chart showing a test operation for a cache memory according to the present invention;

FIG. 5 is a timing chart showing a test operation for a cache memory according to the present invention; and

FIG. 6 is a block diagram showing a configuration of a central processing unit according to a second embodiment of the present invention.

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

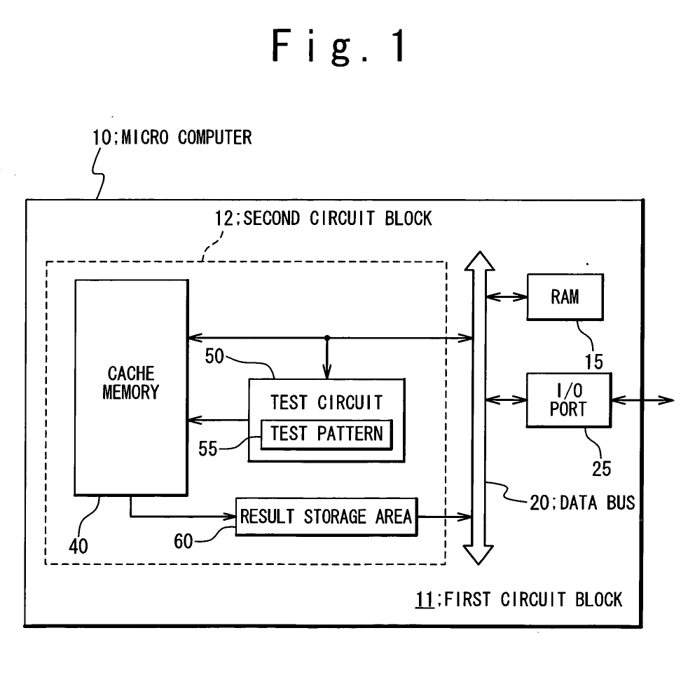

FIG. 1 is a block diagram showing a configuration of a micro computer according to the present invention. In FIG. 1, the micro computer 10 includes a first circuit block 11 and a second circuit block 12. The first circuit block 11 includes a peripheral circuit, and the peripheral circuit is driven based on a clock signal of a predetermined frequency generated by a PLL (Phase Locked Loop) circuit. Hereafter, the clock signal provided for the peripheral circuit is referred to as an “external clock CLK1” or a “first clock”.

On the other hand, the second circuit block 12 includes a CPU (Central Processing Unit). The CPU includes a built-in PLL circuit, and the external clock CLK1 supplied from the outside is made faster by the built-in PLL circuit and is provided for circuits inside the CPU. That is to say, the CPU is driven based on a clock signal whose frequency is higher than that of the external clock CLK1. Hereafter, the clock signal at which the CPU operates is referred to as an “internal clock CLK2”. For example, the frequency of the internal clock CLK2 is four times as high as the frequency of the external clock CLK1.

Also, the second circuit block 12 includes a plurality of cache memories. For example, the CPU includes a built-in first level cache (L1), and the first level cache operates at the internal clock CLK2. The first level cache may include an instruction cache and a data cache. Also, a second level cache (L2) may be provided within the second circuit block 12. For example, the second level cache may operate at the internal clock CLK2, or may operate at half the frequency of the internal clock CLK2. As described above, the second circuit block 12 operates at a “second clock” whose frequency is higher than that of the first clock (external clock CLK1).

As shown in FIG. 1, the first circuit block 11 includes an external RAM 15 and an input-output port (I/O port) 25. The I/O port 25 is used for inputting data to the micro computer 10 and outputting data from the micro computer 10. Also, the second circuit block 12 includes a cache memory 40, a test circuit 50 and a result storage area 60. The cache memory 40, the test circuit 50 and the result storage area 60 in the second circuit block 12 are connected to the external RAM 15 and the I/O port 25 through a data bus 20. Also, the test circuit 50 and the result storage area 60 are connected to the cache memory 40.

The test circuit 50 stores a test pattern 55 which is used for checking the cache memory 40. The test pattern 55 is written (supplied) from the I/O port 25 to the test circuit 50 through the data bus 20, on the basis of the external clock CLK1. That is, the test pattern 55 is programmable. The test circuit 50 instructs the reading and writing of data to the cache memory 40 according to the test pattern 55. Here, the instruction is carried out at the second clock whose frequency is higher than that of the external clock CLK1. When data is read out from the cache memory 40, the read-out data is stored in the result storage area 60. Then, the data is outputted from the result storage area 60 to the I/O port 25, on the basis of the external clock CLK1.

The configuration of the micro computer 10 and operations of the test circuit 50 according to the present invention will be described below in further detail. In the following explanation, a test operation for the first level cache (L1) incorporated in the CPU will be shown as a typical example. A test operation for the second level cache (L2) is carried out in a similar way to the following explanation. In this case, the test circuit 50 may be provided for each of the L1 and the L2 separately.

### First Embodiment

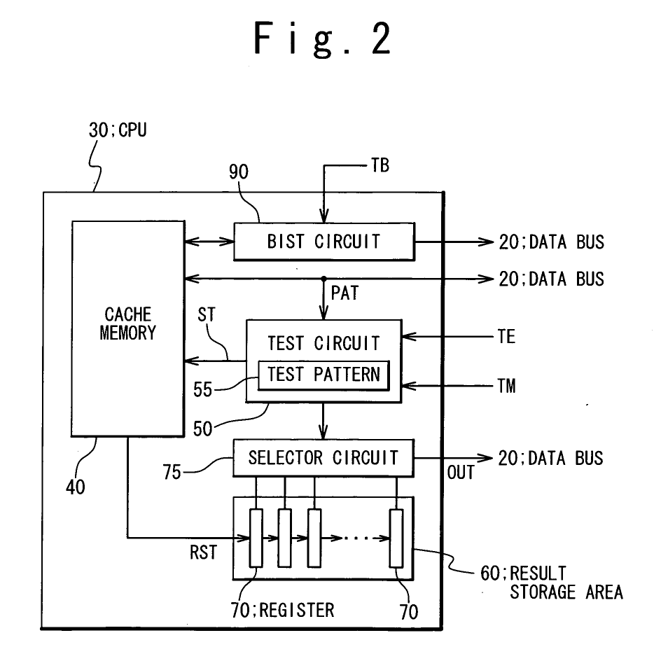

FIG. 2 is a block diagram showing a configuration of the CPU according to the first embodiment of the present invention. The CPU 30 includes a built-in PLL (not shown). The built-in PLL makes the external clock CLK1 inputted from the outside faster, and thus generates the internal clock CLK2.

As shown in FIG. 2, the CPU 30 includes the cache memory 40 as a first level cache, the test circuit 50, the result storage area 60 and a selector circuit 75. The cache memory 40 is connected to the data bus 20 (see FIG. 1), and is usually used for the high-speed operation of the CPU 30. The test circuit 50 is connected to the data bus 20 and the cache memory 40, and operates at the internal clock CLK2. The result storage area 60 is connected through a bus driver to a sense amplifier of the cache memory 40, and stores data which are read out from the cache memory 40 at the time of the test operation. The selector circuit 75 is connected to the data bus 20, the test circuit 50 and the result storage area 60.

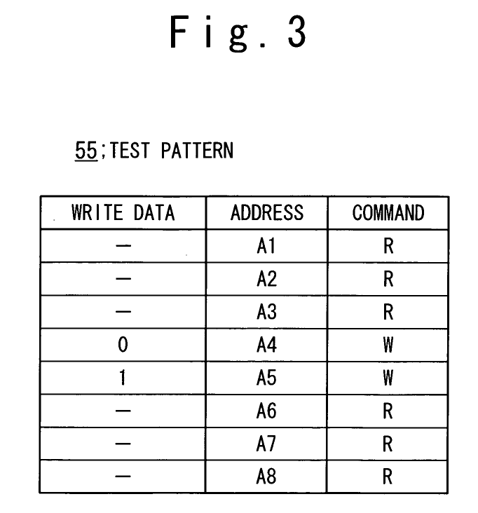

The test circuit 50 stores the test pattern 55 which is used for checking the cache memory 40. FIG. 3 is a table showing an example of contents of the test pattern 55. As shown in FIG. 3, the test pattern 55 includes: write data to be written to the cache memory 40; addresses of respective of access target memory cells; and commands. In the column of the command, “R” indicates a read command, and “W” indicates a write command.

According to the test pattern 55 shown in FIG. 3, eight consecutive commands are executed. That is to say, a data corresponding to an address A1 is first read out. Then, a data corresponding to an address A2 is read out. Then, a data corresponding to an address A3 is read out. Then, a data “0” is written to a memory cell corresponding to an address A4. Then, a data “1” is written to a memory cell corresponding to an address A5. Then, a data corresponding to an address A6 is read out. Then, a data corresponding to an address A7 is read out. Then, and a data corresponding to an address A8 is read.

The contents indicated by the test pattern 55 can be arbitrarily changed and set by a user. For example, the number of the consecutive commands to be executed can be 16. Also, instead of specifying each address, a start point and a skip amount may be specified. Here, in order to detect a failure which may be caused by a “consecutive access”, it is preferable to set the addresses such that an identical word line or an identical bit line is consecutively accessed. Also, the write data can be set (programmed) to the corresponding memory cells at a cache test mode in advance, and only the read commands (R) for consecutively reading data can be set in the test pattern 55.

In the present embodiment, the test pattern 55 can be set from the outside for every test. That is to say, the test pattern 55 is programmable. More specifically, a test setting enable signal TE (see FIG. 2) inputted to the test circuit 50 is first set to “High”. As a result, data inputted from the data bus 20 is supplied to the test circuit 50. By using a tester (terminal) coupled with the I/O port 25, a user inputs a test pattern 55 to the micro computer 10. The inputted test pattern 55 is written to the test circuit 50 through the I/O port 25 and the data bus 20. Here, the writing of the test pattern 55 is carried out according to the external clock CLK1.

After the completion of the writing of the test pattern 55, a test operation with respect to the cache memory 40 is carried out. More specifically, a consecutive test mode signal TM (see FIG. 2) inputted to the test circuit 50 is set to “High”. In response to the consecutive test mode signal TM, the test circuit 50 consecutively outputs a plurality of test signals ST to the cache memory 40. Respective of the plurality of test signals ST indicate the plurality of commands shown in FIG. 3. In other words, the test circuit 50 instructs reading and writing of data to the cache memory 40 in accordance with the test pattern 55. Thus, a write data is written to a predetermined address of the cache memory 40, and a read data is read out from a predetermined address of the cache memory 40. Here, the instructions by the test circuit 50, namely, the reading and the writing of the data to the cache memory 40 are performed according to the internal clock CLK2.

In the above-mentioned reading/writing operation, a data (referred to as a result data RST, hereinafter) may be read out from the cache memory 40. When at least one result data RST is read out from the cache memory 40, the result data RST is stored in the result storage area 60. As shown in FIG. 2, the result storage area 60 includes, for example, a plurality of registers 70. Each of the plurality of registers 70 stores one result data RST. That is, when the read-out result data RST is a one-bit data, each register 70 is a one-bit register. When the read-out result data RST is a 64-bit data, each register 70 is a 64-bits register. When the result data RST is a plural-bits data, the result data RST is inputted to the register 70 in parallel.

When a plurality of result data RST are read out from the cache memory 40, the plurality of result data RST are sequentially stored in the plurality of registers 70. That is, the plurality of registers 70 serve as a shift register as shown in FIG. 2. For example, when the read-out result data RST is a 64-bit data, the result data RST shifts in the plurality of registers 70 in parallel. As a result, all of the plurality of result data RST are stored in the plurality of registers 70. The storing operations of the plurality of result data RST into the result storage area 60 are carried out in accordance with the internal clock CLK2.

After a predetermined period, the at least one result data RST stored in the result storage area 60 is outputted to the I/O port 25 through the data bus 20. As shown in FIG. 2, for example, the selector circuit 75 sequentially outputs to the I/O port 25 as output signals OUT the plurality of result data RST stored in respective of the plurality of registers 70. The selecting operation by the selector circuit 75 is controlled by a control signal from the test circuit 50. The outputting operations of the plurality of result data RST to the I/O port 25 are carried out on the basis of the external clock CLK1.

As described above, according to the CPU 30 and the micro computer 10 of the present invention, the reading and the writing of the test data to the cache memory 40 are consecutively carried out based on the internal clock CLK2. It is therefore possible to detect a failure of the cache memory 40 which is caused by the “consecutive access” based on the internal clock CLK2. Also, all the result data RST read out from the cache memory 40 are stored in the result storage area 60 and can be outputted from the I/O port 25. It is therefore possible to analyze the failure of the cache memory 40 in detail and hence to make. it easier to specify a cause of the failure. Moreover, the test pattern 55 is programmable and is not fixed beforehand. Based on the outputted result data, a user can set a new test pattern 55 by using a tester. The user can recognize the type of the test pattern 55 when the failure is detected. Thus, it is possible to narrow down the cause of failure of the cache memory 40 with ease.

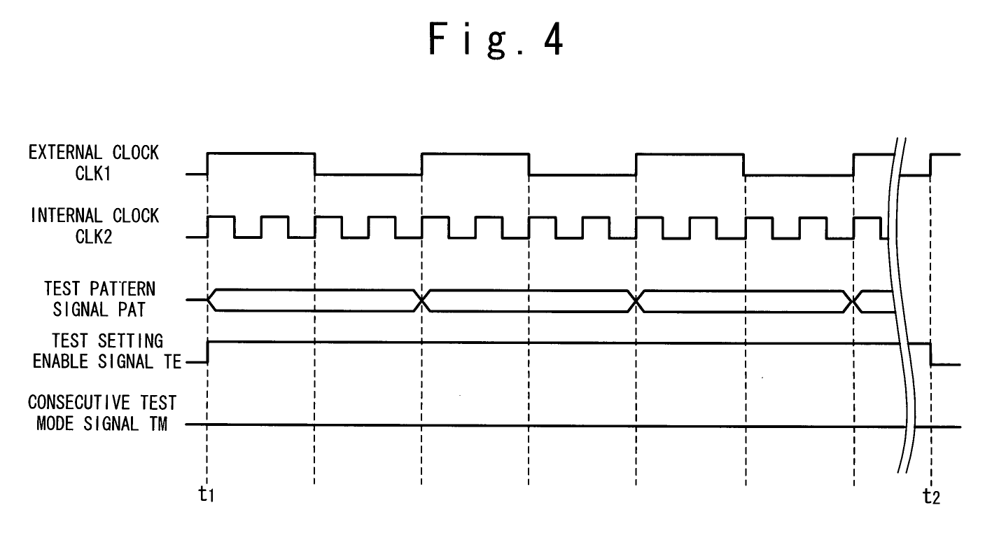

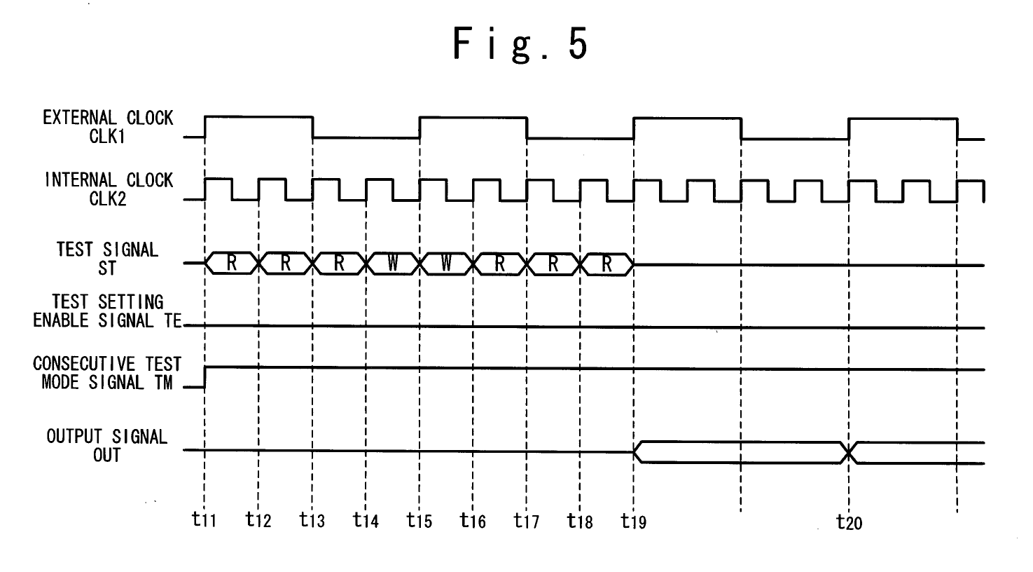

One example of the test operation for the cache memory 40 according to the present embodiment will be described below with reference to timing charts shown in FIGS. 4 and 5. Shown in FIG. 4 are the external clock CLK1, the internal clock CLK2, a test pattern signal PAT, the test setting enable signal TE and the consecutive test mode signal TM. Shown in FIG. 5 are the external clock CLK1, the internal clock CLK2, the test signal ST, the test setting enable signal TE, the consecutive test mode signal TM and the output signal OUT. In the present example, as shown in FIGS. 4 and 5, the frequency of the internal clock CLK2 is four times as high as the frequency of the external clock CLK1. It should be noted that although the following explanation is described on the basis of a positive logic, the test circuit 50 can operate in accordance with a negative logic.

First, as shown in FIG. 4, the test setting enable signal TE is set to High at the time t1. As a result, data inputted from the data bus 20 is supplied to the test circuit 50. By using a tester coupled with the I/O port 25, a user inputs the test pattern 55 shown in FIG. 3 to the micro computer 10, for example. The test pattern signals PAT indicating the inputted test pattern 55 are inputted to the test circuit 50 through the I/O port 25 and the data bus 20. Here, the inputting operations of the test pattern signals PAT (test pattern 55) are carried out in accordance with the external clock CLK1, as shown in FIG. 4. After the completion of the writing of the test pattern 55, the test setting enable signal TE is changed to Low at the time t2.

Next, as shown in FIG. 5, the consecutive test mode signal TM is set to High at the time t11. As a result, the test circuit 50 begins to output the plurality of test signals ST corresponding to the test pattern 55 shown in FIG. 3 consecutively to the cache memory 40. The outputting operations of the plurality of test signals ST are carried out consecutively in accordance with the internal clock CLK2, as shown in FIG. 5. Then, the reading or the writing of the data is executed in the cache memory 40 according to each of the plurality of test signals ST.

More specifically, in a period from the time t11 to the time t12, a data corresponding to the address A1 is read out, and the read result data RST is stored in a register 70 of the result storage area 60. In a period from the time t12 to the time t13, a data corresponding to the address A2 is read out, and the read result data RST is stored in the register 70 of the result storage area 60. The former result data RST corresponding to the address A1 shifts to the adjacent register 70. In a period from the time t13 to the time t14, a data corresponding to the address A3 is read out, and the read result data RST is stored in the register 70 of the result storage area 60. Respective of the former result data RST corresponding to the addresses A1 and A2 shift to the adjacent registers 70.

In a period from the time t14 to the time t15, a data “0 ” is written to a memory cell corresponding to the address A4. In a period from the time t15 to the time t16, a data “1” is written to a memory cell corresponding to the address A5. After that, in a period from the time t16 to the time t19, data corresponding to respective of the addresses A6, A7 and A8 are read out, and the respective read result data RST are stored in the registers 70 of the result storage area 60. The already-stored result data RST shift to the respective adjacent registers 70. In this manner, the reading and the writing of the test data to the cache memory 40 are consecutively carried out on the basis of the internal clock CLK2. It is therefore possible to detect a failure of the cache memory 40 which may be caused by a “consecutive access” according to the internal clock CLK2.

The outputting of the plurality of result data RST stored in the plurality of registers 70 starts at the time t19. This can be attained, for example, by setting the test circuit 50 to output the control signal eight internal clock cycles after the time t11 when the consecutive test mode signal TM is changed to High. It should be noted that the timing of the commencement of the outputting of the result data RST can be set arbitrarily.

When receiving the control signal from the test circuit 50, the selector circuit 75 sequentially reads the plurality of result data RST from the plurality of registers 70. The plurality of output signals OUT indicating respective of the plurality of result data RST are outputted through the data bus 20 to the I/O port 25. Here, the outputting operations of the plurality of output signals OUT are carried out on the basis of the external clock CLK1, as shown in FIG. 5. For example, in a period from the time t19 to the time t20, one output signal OUT corresponding to one result data RST is outputted to the I/O port 25. Also, in a cycle from the time t20, one output signal OUT corresponding to another result data RST is outputted to the I/O port 25. In this manner, all the result data RST read out from the cache memory 40 can be outputted from the I/O port 25 to the outside of the micro computer 10. Thus, it is possible to analyze the failure of the cache memory 40 in detail, and hence it becomes easier to specify the cause of the failure.

In the foregoing example, the maximum number of the read-out result data RST is 8. Therefore, eight registers 70 are enough for storing the read-out result data RST. Generally, in order to detect a failure caused by a consecutive access, at least two registers 70 are necessary. Considering the analysis of the result data RST and the actual operation, the number of the registers 70 is preferably consistent with the number of internal clock cycles corresponding to one external clock CLK1. That is to say, it is preferable that the number of the plurality of registers 70 is equal to or more than a ratio of the frequency of the internal clock CLK2 to the frequency of the external clock CLK1. In the foregoing example, the number of the plurality of registers 70 is preferably equal to or more than 4.

It should be noted that the “consecutive test mode” according to the present invention can be used together with the conventional cache test mode and the BIST mode. For example, the write data to be written to the cache memory 40 may be set in the cache test mode beforehand, and only a plurality of read commands for consecutively reading the data may be set as the test pattern 55. Also, as shown in FIG. 2, the CPU 30 according to the present invention can have a BIST (Built-in Self Test) circuit 90 connected to the cache memory 40. The BIST circuit 90 operates in response to a BIST mode signal TB. In this case, when checking the cache memory 40, whether a failure exists or not is first detected by using the BIST mode. If a trouble is detected by the BIST mode, the “consecutive test mode” according to the present invention is carried out and the failure is analyzed in detail on the basis of the obtained result data RST. The result of the analysis can be fed back for refining the built-in test pattern which is programmed in the BIST circuit 90 and is used in the BIST mode.

### Second Embodiment

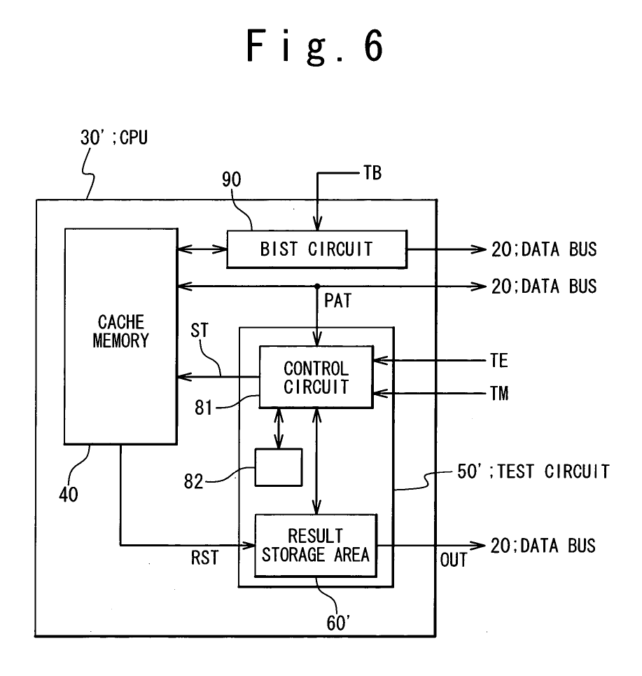

FIG. 6 is a block diagram showing a configuration of a CPU according to the second embodiment of the present invention. In FIG. 6, the same reference numbers are given to the components similar to those shown in the first embodiment, and their explanations are omitted. A CPU 30′ according to the present embodiment includes a cache memory 40 and a test circuit 50′ connected to the cache memory 40. The cache memory 40 and the test circuit 501 are connected to the data bus 20.

As shown in FIG. 6, the test circuit 50′ includes a result storage area 60′, a control circuit 81 and an address/command storage area 82. As in the first embodiment, when the test setting enable signal TE is changed to High, a test pattern 55 is written to the test circuit 50′. As shown in FIG. 3, the test pattern 55 includes a group of write data, addresses and commands. In the present embodiment, the control circuit 81 stores the “write data” of the inputted test pattern 55 in the result storage area 60′, and stores the “addresses and commands” thereof in the address/command storage area 82. In other words, according to the present embodiment, the result storage area 60′ is provided within the test circuit 50′, and is used not only for storing the result data RST but also for storing the test pattern 55.

As in the first embodiment, after the completion of the writing of the test pattern 55, the test operation for the cache memory 40 is carried out on the basis of the internal clock CLK2. That is, when the consecutive test mode signal TM is set to High, the control circuit 81 consecutively outputs a plurality of test signals ST to the cache memory 40. When the result data RST are read out from the cache memory 40, the result data RST are sequentially stored in the result storage area 60′. The result storage area 60′ includes, for example, a shift register consisting of a plurality of registers 70. After that, the result data RST stored in the result storage area 60′ are outputted through the data bus 20 to the I/O port 25.

As described above, according to the second embodiment of the present invention, the same storage area (60′) is shared for storing a part of the test pattern 55 and the result data RST. Thus, in addition to the effects attained in the first embodiment, such an effect that the storage area is reduced can be obtained according to the second embodiment.

It is apparent that the present invention is not limited to the above embodiment, and that may be modified and changed without departing from the scope and spirit of the invention.

1. A central processing unit comprising:
a cache memory;
a test circuit connected to said cache memory; and
a result storage area,
wherein said test circuit stores a test pattern which is programmable and is used for checking said cache memory, and instructs reading and writing of data to said cache memory according to said test pattern, and
a result data read out from said cache memory is stored in said result storage area.

2. The central processing unit according to claim 1,
wherein said result storage area has a shift register including a plurality of registers, and
said result data is sequentially stored in said plurality of registers.

3. The central processing unit according to claim 1,
wherein said test pattern includes a write data which is written to said cache memory,
said result storage area is provided within said test circuit, and
said result storage area stores said result data and said write data.

4. The central processing unit according to claim 1,
further comprising a BIST (Built-in Self Test) circuit connected to said cache memory.

5. A micro computer comprising:
a first circuit block configured to operate at a first clock frequency; and
a second circuit block configured to operate at a second clock frequency which is higher than said first clock frequency,
wherein said second circuit block includes:
a cache memory;
a test circuit connected to said cache memory; and
a result storage area,
wherein said test circuit stores a test pattern which is programmable and is used for checking said cache memory, and instructs reading and writing of data to said cache memory at said second clock frequency according to said test pattern, and
a result data read out from said cache memory is stored in said result storage area.

6. The micro computer according to claim 5,
wherein said result storage area has a shift register including a plurality of registers, and
said result data is sequentially stored in said plurality of registers.

7. The micro computer according to claim 6,
wherein a number of said plurality of registers is equal to or more than a ratio of said second clock frequency to said first clock frequency.

8. The micro computer according to claim 5,
wherein said first circuit block includes an I/O port connected to said second circuit block,
said test pattern is written from said I/O port to said test circuit based on said first clock frequency, and
said result data is outputted from said result storage area to said I/O port based on said first clock frequency.

9. The micro computer according to claim 6,
wherein said first circuit block includes an I/O port connected to said second circuit block,
said test pattern is written from said I/O port to said test circuit based on said first clock frequency, and
said result data is outputted from said result storage area to said I/O port based on said first clock frequency.

10. The micro computer according to claim 7,
wherein said first circuit block includes an I/O port connected to said second circuit block,
said test pattern is written from said I/O port to said test circuit based on said first clock frequency, and
said result data is outputted from said result storage area to said I/O port based on said first clock frequency.

11. The micro computer according to claim 8,
wherein said second circuit block further includes a selector circuit connected to said result storage area, and
said selector circuit sequentially outputs said result data from said result storage area to said I/O port based on said first clock frequency.

12. The micro computer according to claim 5,
wherein said test pattern includes a write data which is written to said cache memory,
said result storage area is provided within said test circuit, and
said result storage area stores said result data and said write data.

13. The micro computer according to claim 6,
wherein said test pattern includes a write data which is written to said cache memory,
said result storage area is provided within said test circuit, and
said result storage area stores said result data and said write data.

14. The micro computer according to claim 7,
wherein said test pattern includes a write data which is written to said cache memory,
said result storage area is provided within said test circuit, and
said result storage area stores said result data and said write data.

15. The micro computer according to claim 8,
wherein said test pattern includes a write data which is written to said cache memory,
said result storage area is provided within said test circuit, and
said result storage area stores said result data and said write data.

16. The micro computer according to claim 9,
wherein said test pattern includes a write data which is written to said cache memory,
said result storage area is provided within said test circuit, and
said result storage area stores said result data and said write data.

17. The micro computer according to claim 10,
wherein said test pattern includes a write data which is written to said cache memory,
said result storage area is provided within said test circuit, and
said result storage area stores said result data and said write data.

18. The micro computer according to claim 11,
wherein said test pattern includes a write data which is written to said cache memory,
said result storage area is provided within said test circuit, and
said result storage area stores said result data and said write data.

19. The micro computer according to claim 5,
further comprising a BIST (Built-in Self Test) circuit connected to said cache memory.

20. A method for checking a micro computer which has a central processing unit operating at a first clock, comprising:
(A) writing a test pattern for checking a cache memory to a first storage area;
(B) writing and reading data to said cache memory at said first clock according to said test pattern;
(C) storing a result data read out from said cache memory in a second storage area; and
(D) outputting said result data from said second storage area to outside of said micro computer.
